(19) United States
(12) Patent Application Publication
(10) Pub. No.: US 2011/0094651 A1
(43) Pub. Date: Apr. 28, 2011

(54) METHOD FOR PRODUCING TRANSPARENT CONDUCTOR

(75) Inventor: Tadashi KURIKI, Minami-ashigara-shi (JP)

(73) Assignee: FUJIFILM CORPORATION, Tokyo (JP)

(21) Appl. No.: 12/910,297

(22) Filed: Oct. 22, 2010

(30) Foreign Application Priority Data
Oct. 22, 2009 (JP) 2009-243441

(51) Int. Cl. H01B 13/32; B82Y 30/00

(52) U.S. Cl. 156/51; 977/932

(57) ABSTRACT

A method for producing a transparent conductor having a substrate and thereon a conductive layer containing a plurality of metal nanowires comprises the steps of applying a metal nanowire dispersion containing the metal nanowires in a liquid to the substrate, removing the liquid from the applied metal nanowire dispersion to form a metal nanowire network layer on the substrate, and subjecting the metal nanowire network layer to a pressure treatment using a lower roller and an upper roller, the lower roller having a rubber hardness of 40° to 70°.

### CROSS-REFERENCE TO RELATED APPLICATION

This application is based upon and claims the benefit of priority from Japanese Patent Application No. 2009-243441 filed on Oct. 22, 2009, of which the contents are incorporated herein by reference.

### BACKGROUND OF THE INVENTION

1. Field of the Invention

The present invention relates to a method for producing a transparent conductor, particularly to a method using a high-throughput coating process for producing a transparent conductor.

2. Description of the Related Art

A transparent conductor contains a highly-transmissive, insulating substrate and a thin conductive film formed thereon. The transparent conductor is produced to show a surface conductivity as well as a sufficient light transmittance. The transparent conductor having a surface conductivity has been widely used as a transparent electrode, an antistatic layer, or an electromagnetic-shielding layer in flat liquid crystal displays, touch panels, electroluminescence devices, thin solar cells, etc.

A known method suitable for producing the transparent conductor is described in US Patent Application Publication No. 2007/0074316. The method contains the steps of depositing a plurality of metal nanowires (in the form of a dispersion in a liquid) on a substrate, and drying the liquid to form a metal nanowire network layer (a layer containing the metal nanowires connected in a network arrangement) on the metal nanowire substrate. In addition, the method may contain the steps of depositing a plurality of metal nanowires (in the form of a dispersion in a liquid) on a substrate, drying the liquid to form a metal nanowire network layer on the substrate, depositing a matrix material on the metal nanowire network layer, and hardening the matrix material to form a matrix, thereby forming a conductive layer containing the matrix and the metal nanowires embedded therein. As described in US Patent Application Publication No. 2007/0074316, a roll-to-roll process may be used in the method. In this process, the substrate is conveyed by a rotary reel along a predetermined path, the metal nanowires are deposited in a first deposition station along the path, and the matrix material is deposited in a second deposition station along the path.

The method described in US Patent Application Publication No. 2007/0074316 is capable of producing the transparent conductor having desired electrical, optical, and mechanical properties on various substrates in a high-throughput process at a low cost.

### SUMMARY OF THE INVENTION

Under such circumstances, an object of the present invention is to improve the method described in US Patent Application Publication No. 2007/0074316, thereby providing a method capable of producing a transparent conductor with more excellent conductivity.

[1] A method according to the present invention for producing a transparent conductor having a substrate and thereon a conductive layer containing a plurality of metal nanowires, wherein the method comprises the steps of applying a coating liquid containing the metal nanowires in a liquid to the substrate, removing the liquid to form a metal nanowire network layer on the substrate, and subjecting the metal nanowire network layer to a pressure treatment using one or more rollers, and at least one roller among the rollers has a rubber hardness of 40° to 70°.

[2] A method according to the invention, wherein in the pressure treatment, a load (line pressure) of 40 kgf/cm or more is applied to the metal nanowire network layer.

[3] A method according to the invention, wherein in the pressure treatment, a load (line pressure) of 40 to 500 kgf/cm is applied to the metal nanowire network layer.

[4] A method according to the invention, wherein the at least one roller is composed of a rubber.

[5] A method according to the invention, wherein in the pressure treatment, first and second rollers are used for applying a pressure to the metal nanowire network layer, the first roller is brought into contact with the substrate, the second roller is arranged facing the first roller and is brought into contact with the metal nanowire network layer, and at least the first roller has a rubber hardness of 40° to 70°.

[6] A method according to the invention, wherein the second roller is composed of a metal.

As described above, the transparent conductor production method of the present invention is capable of producing a transparent conductor with further improved conductivity, useful as a light-transmitting electromagnetic-shielding film for various display devices, a transparent electrode for various electronic devices, a transparent planar heating element, etc.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1A is a cross-sectional view showing a transparent conductor containing a conductive layer and a substrate coated therewith according to an example of the present invention;

FIG. 1B is a cross-sectional view showing a transparent conductor according to another example, and FIG. 1C is a cross-sectional view showing a transparent conductor according to a further example;

FIG. 2 is an explanatory view showing a metal nanowire network incorporated in a matrix;

FIG. 3 is a view showing a process flow of a transparent conductor production method using a roll-to-roll process;

FIGS. 4A to 4C are views showing the steps of a process for transferring a conductive layer onto a substrate by using a laminated structure containing a flexible donor substrate, a release layer, and a conductive layer; and

FIGS. 5A to 5C are views showing the steps of a process for transferring a conductive layer onto a substrate by using a laminated structure containing a flexible donor substrate, a release layer, a conductive layer, an overcoat layer, and an adhesive layer.

### DESCRIPTION OF THE PREFERRED EMBODIMENTS

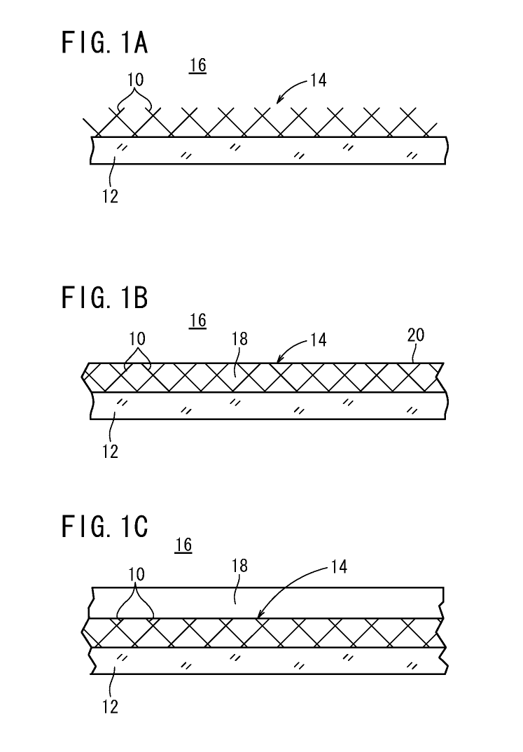

An embodiment of the transparent conductor production method of the present invention will be described below with reference to FIGS. 1A to 5C. It should be noted that, in this specification, a numeric range of “A to B” includes both the numeric values A and B as the lower limit and upper limit values.

A transparent conductor produced by a method according to this embodiment has a conductive layer containing metal nanowires. Particularly, the conductive layer has a sparse network of the metal nanowires. In addition, the conductive layer may be transparent and flexible, may have at least one conductive surface, and may be coated or laminated on various substrates such as soft substrates (flexible substrates) and hard substrates (rigid substrates). The conductive layer may be formed as a part of a composite structure containing a matrix material and the nanowires. The matrix material allows the composite structure to have a particular chemical, mechanical, or optical property.

### [Conductive Nanowires]

Metal nanowires 10 (see FIGS. 1A to 1C) generally have an aspect ratio (length/diameter ratio) of 10 to 100,000. When the metal nanowires 10 have a higher aspect ratio, the overall density of the metal nanowires 10 can be lowered to form a conductive network having higher transparency and efficiency. Therefore, such a higher aspect ratio is preferred in view of forming a transparent conductive layer. In other words, in the case of using the metal nanowires 10 having a higher aspect ratio, the density of the metal nanowires 10 can be sufficiently lowered to form a substantially transparent conductive network. Incidentally, a silver nanowire layer formed on a PET (polyethylene terephthalate) substrate is substantially transparent at approximately 440 to 700 nm.

Conductive nanowires include metal nanowires and other conductive particles having a higher aspect ratio (e.g., higher than 10). Examples of nonmetal nanowires include, but not limited to, carbon nanotubes (CNTs), metal oxide nanowires, conductive polymer fibers, and the like.

The term “metal nanowire” means a metal wire containing an elemental metal, a metal alloy, or a metal compound (which may be a metal oxide). At least one cross sectional dimension of the metal nanowire is less than 500 nm, preferably less than 200 nm, more preferably less than 100 nm. As described above, the aspect ratio (length/width ratio) of the metal nanowire is more than 10, preferably more than 50, more preferably more than 100. The metal nanowire may be suitably composed of any metal, and examples of the metals include, but not limited to, silver, gold, copper, nickel, and gold-plated silver.

The metal nanowire can be prepared by a known method. Particularly, a silver nanowire can be synthesized by reducing a silver salt (e.g., silver nitrate) in the presence of a polyol (e.g., ethylene glycol) and polyvinyl pyrrolidone in a solution phase. Silver nanowires having uniform size can be mass-produced by a method described in Xia, Y., et al., Chem. Mater., 2002, 14, 4736-4745 and Xia, Y., et al., Nanoletters, 2003, 3(7), 955-960, etc.

### [Conductive Layer and Substrate]

A transparent conductor 16 containing a conductive layer 14 and a substrate 12 coated therewith is shown as a specific example in FIG. 1A. The conductive layer 14 contains a plurality of metal nanowires 10. A conductive network is formed by the metal nanowires 10.

A transparent conductor 16 according to another example is shown in FIG. 1B. The transparent conductor 16 of FIG. 1B contains a substrate 12 and a conductive layer 14 formed thereon as well as that of FIG. 1A. However, in FIG. 1B, the conductive layer 14 contains a matrix 18 and a plurality of metal nanowires 10 incorporated therein.

A transparent conductor 16 according to a further example is shown in FIG. 1C. The transparent conductor 16 of FIG. 1C contains a substrate 12 and a conductive layer 14 formed thereon as well as that of FIG. 1A. However, in FIG. 1C, the conductive layer 14 contains metal nanowires 10, which are incorporated in a part of a matrix 18 and completely embedded in the matrix 18.

The term “matrix” means a solid substance in which the metal nanowires 10 are dispersed or incorporated. The metal nanowires 10 may partially protrude from the matrix material to enable access to the conductive network. The matrix 18 acts as a host for the metal nanowires 10, and provides a physical form of the conductive layer 14. The matrix 18 acts to protect the metal nanowires 10 from adverse environmental factors such as corrosion and abrasion factors. Particularly, the matrix 18 can prevent penetration of corrosive components in the atmosphere, such as water, trace of acid, oxygen, and sulfur.

In addition, the matrix 18 allows the conductive layer 14 to have a preferable physical or mechanical property. For example, the adhesion of the conductive layer 14 to the substrate 12 can be improved by the matrix 18. Furthermore, unlike metal oxide films, a polymer matrix or organic matrix containing the metal nanowires 10 can be rigid or flexible. In the case of using a flexible matrix, the transparent conductor 16 can be produced by a low-cost, high-throughput process.

In addition, the optical properties of the conductive layer 14 can be controlled by appropriately selecting the matrix material. For example, reflection loss and undesired glare can be effectively reduced by using a matrix having desired refraction index, composition, and thickness.

In general, the matrix 18 is an optically transparent substance. A substance having a light transmittance of at least 80% in the visible region (400 to 700 nm) is considered as an optically transparent substance.

The matrix 18 has a thickness of approximately 10 nm to 5 μm, approximately 20 nm to 1 μm, or approximately 50 to 200 nm, and has a refraction index of approximately 1.3 to 2.5 or approximately 1.35 to 1.8.

For example, the matrix 18 may be a polymer (referred to also as a polymer matrix). Many optically transparent polymers are known in the art. Examples of suitable polymer matrices include, but not limited to, polyacrylics (such as polymethacrylates including polymethyl methacrylates, polyacrylates, and polyacrylonitriles), polyvinylalcohols, polyesters (such as polyethylene terephthalates (PET), polyester naphthalates, and polycarbonates), polymers having high aromaticity (such as phenol- or cresol-formaldehydes NOVOLACS™, polystyrenes, polyvinyltoluenes, polyvinylxylenes, polyimides, polyamides, polyamide-imides, polyether-amides, polysulfides, polysulfones, polyphenylenes, and polyphenylethers), polyurethanes (PU), epoxy polymers, polyolefins (such as polypropylenes, polymethylpentenes, and cyclic olefin polymers), acrylonitrile-butadiene-styrene (ABS) copolymers, cellulose derivatives, silicones and other silicon-containing polymers (such as polysilsesquioxanes and polysilanes), polyvinyl chlorides (PVC), polyacetates, polynorbornenes, synthetic rubbers (such as EPR, SBR, and EPDM), fluoropolymers (such as polyvinylidene fluorides, polytetrafluoroethylenes (TFE), and polyhexafluoropropylenes), copolymers of fluoroolefins and hydrocarbon olefins (such as LUMIFLON™, and polymers and copolymers of amorphous fluorocarbons (such as CYTOP™ available from Asahi Glass Co., Ltd. and TEFLON™ AF available from Du Pont).

The matrix 18 per se may have conductivity. For example, the matrix 18 may be a conductive polymer. Many conductive polymers are known in the art, and examples thereof include, but not limited to, poly(3,4-ethylenedioxythiophene)s (PEDOT), polyanilines, polythiophenes, and polydiacetylenes.

The term “conductive layer (or conductive film)” means a network layer containing the metal nanowires 10, which acts as a conductive medium of the transparent conductor 16. In the case of using the matrix 18, the combination of the matrix 18 and the network layer containing the metal nanowires 10 may be considered as the conductive layer. The surface conductivity of the conductive layer 14 is in inverse proportion to its surface resistance. It is often referred to as a sheet resistance, and can be measured by a method known in the art.

The matrix 18 has to be filled with a sufficient amount of the metal nanowires 10 to obtain a satisfactory conductivity. The ratio (% by weight) of the metal nanowires 10 in the conductive layer 14, at which the conductive layer 14 has a surface resistivity of approximately 10⁶ ohm/sq or less, is considered as “the standard content”. The standard content depends on the aspect ratio, alignment degree, agglomeration degree, and resistivity of the metal nanowires 10, etc.

The mechanical and optical properties of the matrix 18 are likely to be changed or deteriorated by addition of any particle to the matrix 18. Advantageously, in the case of using silver nanowires having a high aspect ratio as the metal nanowires 10, the conductive network containing the matrix 18 can be such that the standard content is preferably approximately 0.05 to 10 μg/cm², more preferably approximately 0.1 to 5 μg/cm², further preferably approximately 0.8 to 3 μg/cm². The mechanical and optical properties of the matrix 18 are not affected by the content. The values depend strongly on the size and spatial dispersion of the metal nanowires 10. The electrical conductivity (or the surface resistivity) and the light transmittance of the transparent conductor 16 can be advantageously controlled by selecting the content of the metal nanowires 10.

As shown in FIG. 1B, the conductive layer 14 may be distributed over the entire thickness of the matrix 18. A part of the metal nanowires 10 is advantageously exposed on a matrix surface 20 due to the surface tension of the matrix material such as a polymer. This characteristic is particularly preferred in touch screen applications. At least one surface of the transparent conductor 16 exhibits a surface conductivity.

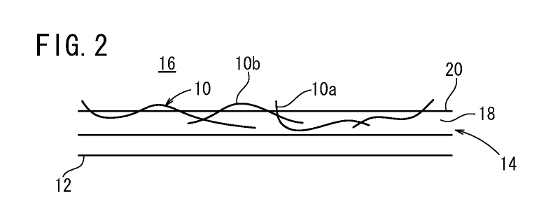

FIG. 2 is a drawing for illustrating a possible cause of the surface conductivity in the network of the metal nanowires 10 incorporated in the matrix 18. As shown in FIG. 2, while some of the metal nanowires 10 may be completely embedded in the matrix 18, an end 10a of the other metal nanowires 10 may protrude from the surface 20 of the matrix 18. Also an intermediate portion 10b of the other metal nanowires 10 may protrude from the surface 20 of the matrix 18. When a sufficient number of the ends 10a and intermediate portions 10b of the metal nanowires 10 protrude from the matrix 18, the surface of the transparent conductor 16 exhibits a conductivity.

The term “substrate (or selected substrate)” means a member that is coated or laminated with the conductive layer 14. The substrate 12 may be rigid or flexible, and may be transparent or opaque. The selected substrate is used in a lamination process to be hereinafter described. Examples of rigid materials suitable for the substrate 12 include glasses, polycarbonates, acrylates, and the like. Examples of flexible materials suitable for the substrate 12 include, but not limited to, polyesters (such as polyethylene terephthalates (PET), polyester naphthalates, and polycarbonates), polyolefins (such as straight, branched, or cyclic polyolefins), polyvinyls (such as polyvinyl chlorides, polyvinylidene chlorides, polyvinyl acetals, polystyrenes, and polyacrylates), cellulose esters (such as cellulose triacetates and cellulose acetates), polysulfones (such as polyethersulfones), polyimides, silicones, and other conventional polymers. Examples of materials suitable for the substrate 12 further include those described in U.S. Pat. No. 6,975,067.

### [Performance-Enhancing Layers]

As described above, the conductive layer 14 can exhibit excellent physical and mechanical properties due to the matrix 18. The properties can be further improved by introducing an additional layer in the transparent conductor 16. For example, one or more of an antireflection layer, an antiglare layer, an adhesive layer, a barrier layer, and a hard coating layer may be formed as the additional layer.

### [Corrosion Inhibitor]

The transparent conductor 16 may contain a corrosion inhibitor in addition to or instead of the above barrier layer. The metal nanowires 10 can be protected by various corrosion inhibitors based on various mechanisms.

The corrosion inhibitor is readily bonded to the metal nanowire 10 to form a protective film on the metal surface. Such a corrosion inhibitor is referred to also as a barrier-forming corrosion inhibitor.

### [Nanowire Deposition and Transparent Conductor Production]

A method for producing the transparent conductor 16 contains the steps of depositing a plurality of the metal nanowires 10 (dispersed in a fluid) on a surface of the substrate 12, and drying the fluid to form a metal nanowire network layer on the substrate 12.

The metal nanowires 10 can be prepared in the above described manner. In general, the metal nanowires 10 are dispersed in a liquid to facilitate the deposition. The terms “deposition” and “coating” are used interchangeably. Any noncorrosive liquid, in which the metal nanowires 10 can be uniformly dispersed to form a coating liquid (referred to as a metal nanowire dispersion or coating liquid), can be used in this step. The metal nanowires 10 are preferably dispersed in water, an alcohol, a ketone, an ether, a hydrocarbon, or an aromatic solvent (such as benzene, toluene, or xylene), and are more preferably dispersed in a volatile liquid having a boiling point of 200° C. or lower, 150° C. or lower, or 100° C. or lower.

An additive or a binder may be added in the coating liquid containing the dispersed metal nanowires 10 to control the viscosity, corrosion, adhesion, and nanowire dispersion. Examples of suitable additives and binders include, but not limited to, carboxymethylcelluloses (CMC), 2-hydroxyethylcelluloses (HEC), hydroxypropylmethylcelluloses (HPMC), methylcelluloses (MC), polyvinylalcohols (PVA), tripropylene glycol (TPG), xanthane gums (XG), surfactants (such as ethoxylates, alcoxylates, ethylene oxide, propylene oxide, and copolymers thereof), sulfonate salts, sulfate salts, disulfonate salts, sulfosuccinate salts, phosphate esters, and fluorosurfactants (such as ZONYL™ available from Du Pont).

In one example, the coating liquid contains 0.0025% to 0.1% by weight of a surfactant (preferably 0.0025% to 0.05% by weight for ZONYL™ FSO-100), 0.02% to 4% by weight of a viscosity modifier (preferably 0.02% to 0.5% by weight for HPMC), 94.5% to 99.0% by weight of a solvent, and 0.05% to 1.4% by weight of the metal nanowires. Typical suitable examples of the surfactants include ZONYL™ FSN, ZONYL™ FSO, ZONYL™ FSH, Triton (x100, x114, and x45), Dynol (604 and 607), n-dodecyl-b-D-maltoside, and NOVEK™. Suitable examples of the viscosity modifiers include hydroxypropylmethylcelluloses (HPMC), methylcelluloses, xanthane gums, polyvinylalcohols, carboxymethylcelluloses, and hydroxyethylcelluloses. Suitable examples of the solvents include water and isopropanol.

The weight percentage of the solvent may be increased or decreased to change the concentration of the coating liquid if necessary. However, in a preferred embodiment, the relative ratios of the other components may be maintained at the same levels. Particularly, the ratio of the surfactant to the viscosity modifier is preferably 0.01 to 80, the ratio of the viscosity modifier to the metal nanowires 10 is preferably 0.000625 to 5, and the ratio of the metal nanowires 10 to the surfactant is preferably 5 to 560. The ratios of the components in the coating liquid may be appropriately changed depending on the substrate and the coating process used. The viscosity of the coating liquid is preferably 1 to 100 cP.

Optionally, by subjecting the substrate 12 to a pretreatment (a surface pretreatment), a surface thereof may be modified to easily deposit the metal nanowires 10 thereon. The surface pretreatment has a plurality of effects. For example, the pretreatment enables the deposition of a uniform nanowire dispersion layer. Furthermore, the pretreatment enables the metal nanowires 10 to be fixed to the substrate 12 in view of the subsequent steps. For the purpose of depositing the metal nanowires 10 in a pattern, the pretreatment may be carried out simultaneously with a pattern forming process. Examples of the pretreatments include solvent or chemical washing treatments, heating treatments, treatments of depositing an optionally patterned intermediate layer for modifying a chemical or ionic state of the coating liquid, and further surface treatments such as plasma treatments, UV-ozone treatments, and corona discharge treatments.

After the deposition, the liquid is removed by evaporation. The evaporation may be accelerated by heating (e.g., firing). Thus obtained metal nanowire network layer may be subjected to a posttreatment for increasing the conductivity. The posttreatment may be a process containing a heating, plasma, corona discharge, UV-ozone, or pressure treatment as described below.

The method according to this embodiment for producing the transparent conductor 16 contains the steps of depositing a plurality of the metal nanowires 10 (dispersed in a fluid) on a surface of the substrate 12, drying the fluid to form the metal nanowire network layer on the substrate 12, coating the metal nanowire network layer with the matrix material, and hardening the matrix material to form the matrix 18.

The term “matrix material” means a material or a mixed material that can be hardened to form a matrix. In the hardening, a monomer or a partial polymer (containing less than 150 monomer units) may be polymerized and/or crosslinked to form a solid polymer matrix. Suitable conditions for the polymerization are known in the art. For example, the monomer may be polymerized by heating or irradiation with a visible light, an ultraviolet (UV) light, an electron beam, etc. In addition, the hardening may be solidification of the polymer/solvent system caused by removing the solvent.

The matrix material may contain a polymer, which may be selected from the above described polymers. Alternatively, the matrix material may contain a prepolymer. The term “prepolymer” means a mixture of a monomer, an oligomer, or a partial polymer that can be polymerized and/or crosslinked to form the polymer matrix. A suitable monomer or partial polymer can be selected depending on the desired polymer matrix within the knowledge of those skilled in the art.

In a preferred embodiment, the prepolymer is a light-hardening substance, and thus it is polymerized and/or crosslinked by light irradiation. More specifically, the matrix 18 can be formed in a pattern by irradiating a selected portion of the light-hardening prepolymer with a light. The prepolymer may be a heat-hardening substance, which may be selectively heated by a heat source to form a patterned matrix.

The matrix material is generally in a liquid state. The matrix material may optionally contain a solvent. Any noncorrosive solvent, in which the matrix material can be efficiently solvated or dispersed, can be used for the matrix material. Suitable examples of the solvents include water, alcohols, ketones, tetrahydrofuran, hydrocarbons (such as cyclohexane), and aromatic solvents (such as benzene, toluene, and xylene). It is further preferred that the solvent is volatile and has a boiling point of 200° C. or lower, 150° C. or lower, or 100° C. or lower.

The matrix material may contain a crosslinker, a polymerization initiator, a stabilizer (such as an antioxidant or a UV stabilizer for increasing the product lifetime, or a polymerization inhibitor for increasing the storage life), a surfactant, etc. The matrix material may further contain a corrosion inhibitor.

The transparent conductor 16 may be produced by sheet coating, web coating, printing, laminating, etc.

### <(a) Sheet Coating>

The sheet coating is suitable for coating any substrate 12 (particularly a highly rigid substrate 12) with the conductive layer 14.

In the transparent conductor production using the sheet coating process, first, the coating liquid (not shown) is applied to the substrate 12. A roller is rotated across the upper surface of the substrate 12, so that a metal nanowire dispersion layer (a layer containing the metal nanowires 10 dispersed) remains on the upper surface of the substrate 12. The metal nanowire dispersion layer is then dried to form the metal nanowire network layer on the upper surface of the substrate 12.

In some cases, the substrate 12 has to be pretreated to deposit a uniform metal nanowire dispersion layer thereon. Examples of the pretreatments include solvent or chemical washing treatments, heating treatments, treatments of depositing an optionally patterned intermediate layer for modifying a chemical or ionic state of the metal nanowire dispersion layer, and further surface treatments such as plasma treatments, UV-ozone treatments, and corona discharge treatments.

For example, the intermediate layer may be deposited on the surface of the substrate 12 to fix the metal nanowires 10. The intermediate layer may act to functionalize or modify the surface of the substrate 12, thereby accelerating the bonding of the metal nanowires 10 to the surface of the substrate 12. The intermediate layer may be formed on the substrate 12 before the deposition of the metal nanowires 10, and may be co-deposited with the metal nanowires 10.

In some cases, the formed metal nanowire network layer has to be subjected to a posttreatment for increasing the conductivity. The posttreatment may be a process containing a heating, plasma, corona discharge, UV-ozone, or pressure treatment as described in more detail below.

The metal nanowire network layer is coated with the matrix material by using a roller or the like, to form a layer composed of the matrix material (a matrix material layer). The matrix material layer is hardened, whereby the matrix 18 is formed to obtain the transparent conductor 16 having a structure of FIGS. 1A to 1C and 2.

A brush, a stamp, a spray coater, a slot-die coater, or any other suitable coater may be used instead of the roller. In addition, as discussed further below, the metal nanowires 10 may be deposited on the substrate 12 by reverse or forward gravure printing, slot die coating, reverse or forward bead coating, or drawdown table. The conductive layer 14 can be advantageously formed in a pattern by using a roller or stamp having a patterned recess for printing (e.g., gravure-printing) a patterned metal nanowire dispersion layer or matrix material layer. The conductive layer 14 can be formed in a pattern by spraying the substrate 12 with the metal nanowires 10 or the matrix material through an open mask. In a case where the matrix material is deposited or hardened in a pattern, the pattern can be transferred to the metal nanowire dispersion layer. The metal nanowires 10 can be removed by washing with a suitable solvent, brushing, or transferring to a sticky or adhesive roller.

It is to be understood that an additional deposition or coating process may be carried out, and a drying or hardening step may be performed between two successive coating processes. For example, any number of the performance-enhancing layers may be formed in the above manner.

### <(b) Web Coating>

The web coating process has been used for high-speed (high-throughput) coating in the fabric and paper industries. The web coating process is suitable for the deposition (coating) in the production of the transparent conductor 16. Advantageously, the web coating process can be sufficiently automated using a conventional apparatus, whereby the production cost of the transparent conductor 16 can be remarkably reduced. Particularly, the web coating process is suitable for reproducibly forming a uniform conductive layer on a flexible substrate. The process can be continuously carried out in a completely integrated line or in separated sections.

In one embodiment of the web coating, a flexible substrate 12 in the form of a film or web is continuously coated with the metal nanowire dispersion layer while conveying the substrate 12 in one direction. More specifically, the substrate 12 is drawn and conveyed in one direction by a motor, etc. A storage tank is disposed on a conveyance path of the substrate 12. The coating liquid for depositing the metal nanowires is stored in the storage tank. The coating liquid is continuously flowed from an opening of the storage tank onto the substrate 12, so that the metal nanowire dispersion layer is continuously formed on the substrate 12.

The matrix material may be stored in another storage tank, and the matrix material may be applied in the same manner as above.

Any disperser may be used instead of the storage tank, and examples thereof include spray devices (such as an atomizer that delivers a pressurized dispersion), brushing devices, and injectors. Alternatively, a printing device may be used for pattern coating in the web coating process as well as the sheet coating process.

In another embodiment of the web coating, the metal nanowire dispersion layer is continuously formed on the bottom surface of the substrate 12. In this case, the substrate 12 is conveyed in one direction. A roller used for the coating is disposed below the substrate 12, and is partially submerged in the coating liquid stored in the storage tank. The coating liquid is supplied to the bottom surface of the substrate 12 by the coating roller, to continuously form the metal nanowire dispersion layer on the bottom surface of the substrate 12. The coating roller is rotatable in the substrate conveying direction or the reverse direction. The matrix material may be applied in the same manner.

It is to be understood that, in the web coating, various surface treatments may be carried out before or after each deposition process. The transmittance and/or conductivity of the conductive layer 14 can be improved by the surface treatment as described in detail below. Suitable examples of the surface treatments include, but not limited to, solvent or chemical washing treatments, plasma treatments, corona discharge treatments, UV/ozone treatments, pressure treatments, and combinations thereof.

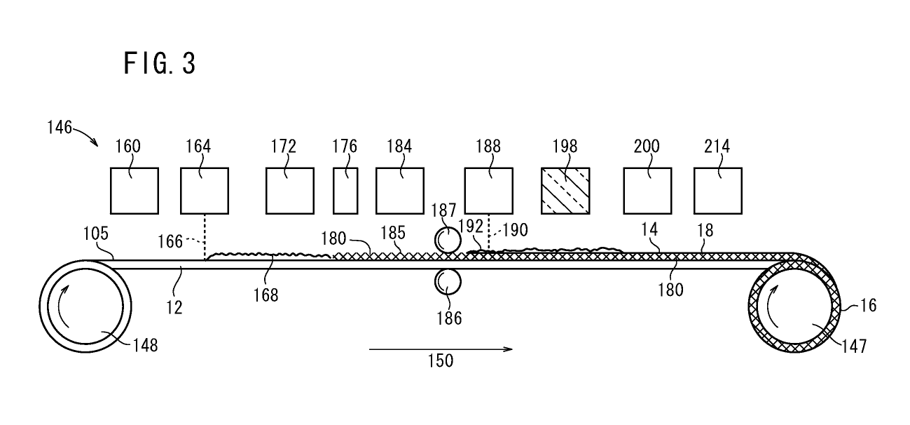

A comprehensive process flow for producing the transparent conductor 16 is shown in FIG. 3. As shown in FIG. 3, a web coating system 146 has a take-up roll 147 that is actuated by a motor (not shown). The substrate 12 (such as a flexible polymer film) is drawn from a supply roll 148 along a conveyance path 150 by the take-up roll 147. The substrate 12 is continuously treated and coated along the conveyance path 150.

In this embodiment, the substrate 12 is subjected to a pretreatment in view of preparation for the subsequent coating process. More specifically, in a pretreatment station 160, the substrate 12 may be optionally subjected to a surface treatment for improving the efficiency of the following nanowire deposition. By performing the surface treatment of the substrate 12 before the deposition, the uniformity of the metal nanowires 10 deposited in the subsequent process can be improved.

The surface treatment may be selected from treatments known in the art. For example, a plasma surface treatment may be carried out to modify the molecular structure in the surface of the substrate 12. In the plasma surface treatment, a highly reactive species can be generated at low temperature by using a gas of argon, oxygen, nitrogen, etc. In general, because only a few atomic layers on the surface are modified in the treatment, the bulk property of the substrate 12 (such as a polymer film) is not changed by the chemical conversion. In many cases, by the plasma surface treatment, the surface can be suitably activated to improve the wetting property and adhesion bonding property. In a specific example, an oxygen plasma treatment may be carried out in March PX250 system using the following operation parameters: 150 W, 30 seconds, O₂ flow rate of 62.5 sccm, and pressure of about 400 mTorr.

An intermediate layer may be deposited on the substrate 12 by the surface treatment. As described above, the intermediate layer generally has affinity for both the metal nanowire 10 and the substrate 12. Therefore, the metal nanowires 10 can be fixed or attached to the substrate 12 by using the intermediate layer. Typical examples of substances suitable for the intermediate layer include multifunctional biomolecules such as polypeptides (e.g., poly-L-lysines).

Further typical examples of the surface treatments include solvent washing treatments, corona discharge treatments, and UV/ozone treatments, which are known in the art.

Then, the substrate 12 is transported to a metal nanowire deposition station 164 for supplying a coating liquid 166. The deposition station 164 may be the storage tank, spray device, brushing device, etc. described above in terms of the web coating process. A metal nanowire dispersion layer 168 is deposited on a surface 105 of the substrate 12. The metal nanowire dispersion layer 168 may be formed in a pattern on the substrate 12 by using a printing device. For example, a stamp or roller having a patterned recess may be used in the printing device. The stamp or roller can be continuously applied to the metal nanowire dispersion layer 168 by a method known in the art.

The metal nanowire dispersion layer 168 may be optionally rinsed in a rinse station 172. Then, the metal nanowire dispersion layer 168 is dried in a drying station 176 to form a metal nanowire network layer 180.

The metal nanowire network layer 180 may be optionally treated in a posttreatment station 184. For example, the metal nanowires 10 may be surface-treated with argon or oxygen plasma to improve the transmittance and conductivity of the metal nanowire network layer 180. In a specific example, an Ar or N₂ plasma treatment may be carried out in March PX250 system using the following operation parameters: 300 W, 90 seconds (or 45 seconds), Ar or N₂ gas flow rate of 12 sccm, and pressure of about 300 mTorr. The metal nanowire network layer 180 may be subjected to another known surface treatment (such as a corona discharge or UV/ozone treatment). For example, the corona treatment may be carried out in Enercon system.

A pressure treatment of the metal nanowire network layer 180 may be carried out as a part of the posttreatment. More specifically, the metal nanowire network layer 180 is introduced between a lower roller 186 and an upper roller 187, and a pressure is applied to a surface 185 of the metal nanowire network layer 180 by the lower roller 186 and the upper roller 187. Only one roller may be used in the pressure treatment.

The conductivity of the conductive layer can be advantageously improved by subjecting the metal nanowire network layer 180 to the pressure treatment particularly before the application of a matrix material 190. An intermediate workpiece to be converted to the final product of the transparent conductor 16 (such as a workpiece having the substrate 12 and thereon the metal nanowire network layer 180 and a workpiece having the matrix in the metal nanowire network layer 180) is hereinafter referred to as the transparent conductor precursor.

Specifically, a pressure may be applied to one or both surfaces of the sheet transparent conductor precursor according to the embodiment by using one or more rollers (such as cylindrical bars). The lengths of the one or more rollers may be larger than the width of the conductive layer, though not restrictive. In the case of using only one roller, the metal nanowire network layer 180 may be formed on a surface of a highly rigid substrate 12, and the roller may be pressed to and rolled on a surface, on which the conductive layer 14 is exposed by a known method. In the case of using two rollers, as shown in FIG. 3, the metal nanowire network layer 180 may be pressed by the lower roller 186 and the upper roller 187. In this embodiment, the lower roller 186 and the upper roller 187 are arranged facing each other, the lower roller 186 is brought into contact with the substrate 12, the upper roller 187 is brought into contact with the metal nanowire network layer 180, so that the metal nanowire network layer 180 is pressed. The lower roller 186 has a rubber hardness of 40° to 70°. When the lower roller 186 has an excessively high rubber hardness, the substrate 12 may be disadvantageously deformed or broken. On the other hand, when the lower roller 186 has an excessively low rubber hardness, a sufficient pressure is not applied to the metal nanowire network layer 180, thereby failing to improve the conductivity, in some cases.

The lower roller 186 is preferably a rubber roller containing a chloroprene polymer rubber as a main component. The upper roller 187 is preferably a metal roller having a hard chrome plating layer. In this embodiment, a load (line pressure) is applied to the metal nanowire network layer 180 in the pressure treatment using the lower roller 186 and the upper roller 187, and the load is 40 kgf/cm or more, preferably 40 to 500 kgf/cm.

In the case of using two or more rollers for applying a pressure to the transparent conductor precursor, nip or pinch rollers may be used. The nip and pinch rollers are well understood in the art, and described in 3M Technical Bulletin, “Lamination Techniques for Converters of Laminating Adhesives”, March 2004, etc.

It has been found that the conductivity of the metal nanowire network layer 180 can be improved by subjecting the metal nanowire network layer 180 to the pressure treatment before or after the above plasma treatment, and the pressure treatment may be carried out whether the plasma treatment is performed or not. As shown in FIG. 3, the lower roller 186 and the upper roller 187 may be rotated once or more on the surface 185 of the metal nanowire network layer 180. In a case where the roller is rolled plural times on the metal nanowire network layer 180, the rolling may be carried out in a direction of an axis parallel to the surface of the sheet to be treated (e.g., along the conveyance path 150) or in a different direction (not shown).

For example, in a case where a stainless steel roller is used as the upper roller 187, a rubber roller is used as the lower roller 186, and a line pressure of 40 to 500 kgf/cm is applied to the metal nanowire network layer 180, the resultant conductive network of the metal nanowires 10 has a plurality of nanowire intersections. In at least the intersections, the upper metal nanowires 10 are pressed to each other and have a flattened cross section, whereby the connection as well as the conductivity of the conductive network of the metal nanowires 10 is improved.

The transparent conductor precursor may be heated in a posttreatment. In general, the transparent conductor precursor may be heated at a temperature of 80° C. to 250° C. for 10 minutes or less, preferably at a temperature of 100° C. to 160° C. for 10 seconds to 2 minutes. The transparent conductor precursor may be heated at a high temperature of 250° C. to 400° C. depending on the type of the substrate 12. For example, a glass substrate may be heated at a temperature of 350° C. to 400° C. However, a non-oxidizing atmosphere of a nitrogen gas, a noble gas, etc. may be required in the posttreatment at a higher temperature (e.g., higher than 250° C.).

The heating treatment may be carried out in on- or off-line manner. For example, in an off-line treatment, the transparent conductor precursor may be placed in a sheet oven (an oven capable of drying a sheet) at a predetermined temperature for a predetermined time. The conductivity of the transparent conductor 16 according to the present invention can be improved by heating the transparent conductor precursor in this manner. For example, in this embodiment, in a roll-to-roll process for producing the transparent conductor 16 shown in FIG. 3, the surface resistivity of the transparent conductor precursor can be lowered from approximately 12 kohm/sq to approximately 58 ohm/sq by placing the precursor in the above sheet oven at 200° C. for 30 seconds in the heat posttreatment.

In another example, the surface resistivity of the transparent conductor precursor can be lowered from approximately 19 kohm/sq to approximately 400 ohm/sq by heating the precursor in the sheet oven at 100° C. for 30 seconds. The transparent conductor precursor may be heated by means other than the sheet oven. For example, the precursor may be heated by an in- or off-line method using an infrared lamp. The metal nanowire network layer 180 may be heated by an RF current. The RF current may be generated in the metal nanowire network layer 180 by a broadcast microwave or a current induced through an electrical contact to the network layer 180.

Furthermore, both of heat and pressure may be applied to the transparent conductor precursor in the posttreatment. Particularly, to apply pressure, the precursor may be placed on one or more rollers as described above. The roller may be heated to simultaneously apply heat. The pressure applied by the roller is preferably 10 to 500 psi, more preferably 40 to 200 psi. The temperature of the roller is preferably 70° C. to 200° C., more preferably 100° C. to 175° C. The conductivity of the transparent conductor 16 can be improved by using the combination of heating and pressurization. Devices capable of simultaneously applying suitable pressure and heat include laminators manufactured by Banner American Products of Temecula, Calif. The combination of heating and pressurization may be carried out before or after the deposition and hardening of the matrix or another layer to be hereinafter described.

Another posttreatment for improving the conductivity of the transparent conductor 16 according to the present invention contains bringing the metal wire conductive network into contact with a metal reducing agent. Particularly, a silver nanowire conductive network may be in contact with a silver reducing agent such as sodium borohydride, preferably for 10 seconds to 30 minutes, more preferably for 1 to 10 minutes. The treatment may be carried out in an in- or off-line manner within the knowledge of those skilled in the art.

As described above, such treatments enable to improve the conductivity of the transparent conductor 16. For example, in a case where silver nanowires are disposed on a PET substrate to obtain the transparent conductor 16 by the above roll-to-roll process, the silver nanowires may be brought into contact with 2% NaBH₄ for 1 minute, rinsed in water, and dried in air. The resistivity of the transparent conductor precursor is lowered from approximately 134 ohm/sq to approximately 9 ohm/sq by the posttreatment. In another example, in a case where silver nanowires are disposed on a glass substrate to obtain the transparent conductor 16, the silver nanowires may be brought into contact with 2% NaBH₄ for 7 minutes, rinsed in water, and dried in air. The resistivity of the transparent conductor precursor is lowered from approximately 3.3 Mohm/sq to approximately 150 ohm/sq by the posttreatment. A reducing agent other than sodium borohydride may be used in the posttreatment. Suitable examples of the reducing agents include borohydrides (such as sodium borohydride), boron nitrogen compounds (such as dimethylaminoborane (DMAB)), and reducing gases (such as hydrogen gas (H₂)).

The substrate 12 is then transported to a matrix deposition station 188 for supplying the matrix material 190. The matrix deposition station 188 may be the storage tank, spray device, brushing device, printing device, etc. described above in terms of the web coating process. A matrix material layer 192 is deposited on the metal nanowire network layer 180. The matrix material layer 192 may be advantageously formed in a pattern by using a printing device.

The matrix material layer 192 is hardened in a hardening station 200. When the matrix material has a polymer/solvent system, the matrix material layer 192 can be hardened by evaporating the solvent. The hardening may be accelerated by heating (e.g., firing). In a case where the matrix material contains a radiation-hardening prepolymer, the matrix material layer 192 can be hardened by irradiation. The matrix material layer 192 may be hardened by heating (thermally induced polymerization) depending on the type of the prepolymer.

A patterning step may be optionally carried out before the hardening of the matrix material layer 192. A patterning station 198 may be disposed downstream of the matrix deposition station 188 and upstream of the hardening station 200. The patterning step will be described in detail hereinafter.

The conductive layer 14 containing the metal nanowire network layer 180 in the matrix 18 is formed by the hardening. The conductive layer 14 may be further treated in a posttreatment station 214.

In one embodiment, the conductive layer 14 is subjected to a surface treatment in the posttreatment station 214, so that the metal nanowires 10 are partially exposed from the surface of the conductive layer 14. For example, a slight amount of the matrix can be etched and removed by a solvent, plasma, corona discharge, or UV/ozone treatment. The exposed portion of the metal nanowires 10 is particularly suitable for touch screen applications.

In another embodiment, the metal nanowires 10 are partially exposed from the surface of the conductive layer 14 after the hardening without the etching (see FIG. 2). Particularly, by appropriately controlling the thickness of the matrix material layer 192 and the surface tension of the matrix material, an upper portion of the metal nanowire network containing the metal nanowires 10 can be prevented from being wetted with the matrix 18 and can be exposed on the surface of the conductive layer 14.

The conductive layer 14 and the substrate 12 are then drawn by the take-up roll 147. This production flow process is referred to as a reel-to-reel or roll-to-roll process. The substrate 12 can be optionally stabilized by transporting along a conveyer belt.

In the roll-to-roll process, the plural coating steps may be carried out along the conveyance path of the substrate 12. Thus, the web coating system 146 may be customized or modified to be equipped with any number of additional coating stations, if necessary. For example, the coating of the performance-enhancing layer (such as a layer or film for antireflection, adhesion, barrier, antiglare, or protection purpose) can be easily incorporated in the flow process.

The roll-to-roll process is advantageously capable of producing a uniform transparent conductor at high rate and low cost. Particularly, the coating steps are continuously carried out in the flow process, whereby the resultant coating layer has no trailing edges.

### <(c) Lamination>

Though the roll-to-roll process has broad utility, the process is unsuitable for a substrate 12 composed of a highly rigid material such as a glass. The sheet coating process is capable of coating such a highly rigid substrate 12, and can be carried out on a conveyer belt in some cases. However, edge defect and/or uniformity deterioration are often caused in the sheet coating process. In addition, the sheet coating process is a low-throughput process, thereby resulting in increased production cost.

Thus, a lamination process using a flexible donor substrate for producing the transparent conductor 16 is described below. The lamination process is usable for coating a highly rigid substrate 12 or a flexible substrate 12. More specifically, the lamination process contains the following steps of: (i) coating the flexible donor substrate with the conductive layer 14 containing the plural metal nanowires 10, which may be embedded in the matrix 18; (ii) separating the conductive layer 14 from the flexible donor substrate; and (iii) transferring the conductive layer 14 to a selected substrate 12.

The flexible donor substrate can be advantageously coated with the conductive layer 14 by the roll-to-roll process because of its flexibility. The formed conductive layer 14 can be transferred to the selected substrate 12 (which may be highly rigid or flexible) by a common lamination method. In a case where the matrix material is not used and only the metal nanowires 10 are deposited on the flexible donor substrate, the conductive layer 14 may be attached to the selected substrate 12 using a lamination adhesive.

The flexible donor substrate is a flexible substrate having a shape of sheet, film, web, or the like. The flexible donor substrate is not particularly limited and may be any flexible substrate, as long as it can be separated from the conductive layer 14. The flexible donor substrate may be a woven or nonwoven fabric, a paper, etc. The flexible donor substrate may be optically opaque.

The flexible donor substrate may be preliminary-coated (precoated) with a release layer before coated with the conductive layer 14. The release layer is a thin layer bonded to the donor substrate, and the conductive layer 14 can be formed thereon by the web coating process. The release layer acts to facilitate the removal of the donor substrate from the conductive layer 14 without damaging the conductive layer 14. The release layer is generally composed of a substance having a low surface energy (such as a silicone-based polymer, a fluorinated polymer, or a starch), though the material is not limited thereto.

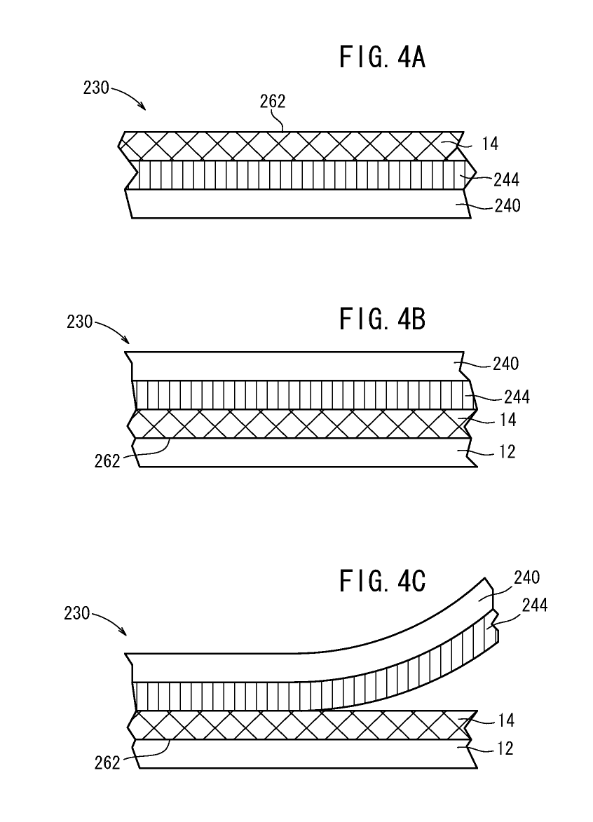

In FIG. 4A, an example of a laminated structure 230 containing a flexible donor substrate 240, a release layer 244 formed on the flexible donor substrate 240, and a conductive layer 14 formed on the release layer 244 is shown.

The laminated structure 230 can be produced using the flexible donor substrate 240 in the same manner as in the process of FIG. 3. The release layer 244 is deposited or coated on the flexible donor substrate 240 before the deposition of the metal nanowires 10. The conductive layer 14 can be formed by depositing the metal nanowires 10 and by depositing a matrix 18 thereon as described herein.

The conductive layer 14 is then uniformity transferred to the selected substrate 12. Though the highly rigid substrate 12 (such as a glass substrate) is generally unsuitable for the roll-to-roll sheet coating process, the conductive layer 14 can be laminated on such highly rigid substrate 12 by the lamination process. As shown in FIG. 4B, a surface 262 of the conductive layer 14 is brought into contact with the substrate 12 (such as a glass substrate), whereby the conductive layer 14 is transferred from the laminated structure 230 to the substrate 12. The polymer matrix (such as a PET, PU, or polyacrylate) is appropriately bonded to the substrate 12. As shown in FIG. 4C, the flexible donor substrate 240 can be removed by separating the release layer 244 from the conductive layer 14.

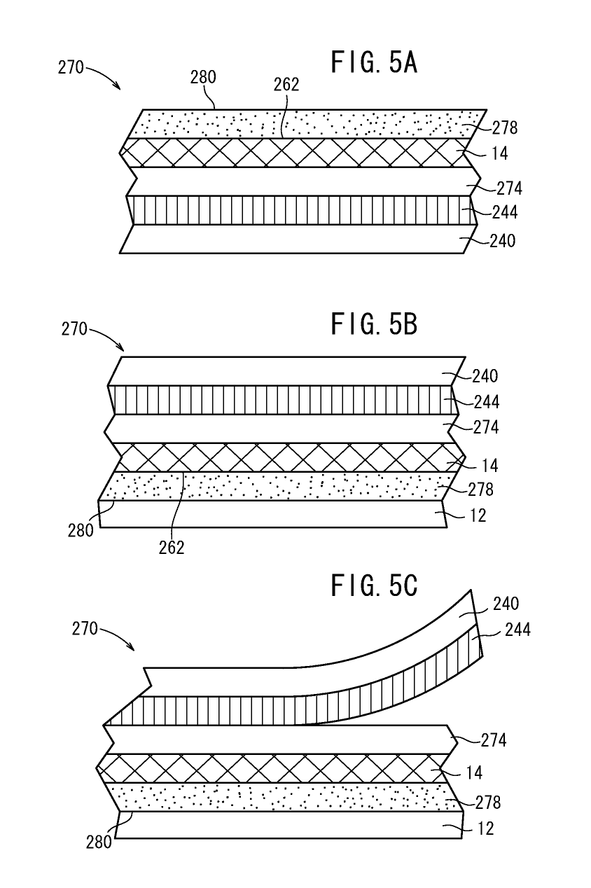

An adhesive layer may be used for improving the bonding between the conductive layer 14 and the substrate 12 in the lamination process. In FIG. 5A, a laminated structure 270 containing an overcoat layer 274 and an adhesive layer 278 in addition to a flexible donor substrate 240, a release layer 244, and a conductive layer 14 is shown. The adhesive layer 278 has an adhesion surface 280.

It is to be understood that the laminated structure 270 can be produced in the same manner as in the roll-to-roll process of FIG. 3 by disposing additional stations for forming the adhesive layer and the overcoat layer in the web coating system 146. The adhesive layer is as defined herein, may be composed of a polyacrylate, a polysiloxane, etc., and may have pressure-sensitive, heat-melting, radiation-hardening, and/or heat-hardening properties. The overcoat layer may contain one or more performance-enhancing layer such as the hard coating layer, the antireflection layer, the protective layer, or the barrier layer.

As shown in FIG. 5B, the laminated structure 270 is bonded to the substrate 12 by the adhesion surface 280. As shown in FIG. 5C, the flexible donor substrate 240 is then removed by separating the release layer 244 from the overcoat layer 274.

Heat or pressure may be applied in the lamination process to improve the bonding between the substrate 12 and the adhesive layer (or the conductive layer 14 not having the adhesive layer).

In a case where the conductive layer 14 has preferable different affinities for the flexible donor substrate 240 and the selected substrate 12, the release layer 244 is not needed. For example, the affinity of the conductive layer 14 for a glass substrate may be significantly higher than that for a fabric donor substrate. In this case, the fabric donor substrate can be removed after the lamination, and the conductive layer 14 can be bonded to the glass substrate.

Pattern transfer can be carried out in the lamination process. For example, the substrate 12 may be heated under a temperature gradient, so that a heated area and an unheated area may be formed thereon in a predetermined pattern. The heated area has an increased affinity (e.g., adhesion property) for the conductive layer 14, and the conductive layer 14 is laminated only on the heated area. Thus, the conductive layer 14 is disposed in the pattern on the substrate 12. For example, the heated area may be formed on the substrate 12 by a nichrome wire heater positioned beneath the heated area on the substrate 12.

The pattern transfer can be carried out utilizing a pressure gradient generated by a matrix material or an adhesive having a pressure-sensitive affinity. For example, a patterned laminating roller may be used for applying different pressures corresponding to a predetermined pattern. The patterned laminating roller may be heated to increase the affinity difference between a pressurized area and a nonpressurized area.

Prior to the lamination process, the conductive layer 14 may be cut (e.g., punched) in a predetermined pattern. When the cut conductive layer 14 is transferred to the substrate 12, the conductive layer 14 of the predetermined pattern is maintained while the rest is removed along the cutting contour.

A transparent conductor such as a metal oxide film has been used in various devices. The transparent conductor 16 according to the present invention can be used as an electrode in any such device. Suitable examples of the devices include flat panel displays, LCDs, touch screens, electromagnetic shields, functional glasses for an electrochromic window or the like, and optoelectronic devices. Furthermore, the transparent conductor according to the present invention can be used in a flexible device such as a flexible display or a touch screen.

The transparent conductor 16 may be used as a part of a touch screen. The touch screen is an interactive input device incorporated in an electronic display. A user touches the screen to input information. The touch screen is optically transparent and has light and image transmittability.

### EXAMPLES

The structure, electrical property, optical property, and production method of the transparent conductor will be described more specifically below with reference to Examples without intention of restricting the scope of the present invention.

### First Example

In First Example, a silver nanowire network layer was used as the metal nanowire network layer 180 shown in FIG. 3. Lower rollers 186 having different rubber hardnesses were used at a constant load (line pressure) in a pressure treatment of the silver nanowire network layer, respectively. Thus, the surface resistance difference between resultant transparent conductors 16 was evaluated.

### Example 1

### Synthesis of Silver Nanowire

Silver nitrate was dissolved in ethylene glycol and reduced in the presence of a polyvinyl pyrrolidone (PVP). The resultant underwent a polyol method described in Y. Sun, B. Gates, B. Mayers, and Y. Xia, “Crystalline silver nanowires by soft solution processing”, Nanoletters, 2002, 2(2), 165-168, to synthesize a silver nanowire. The silver nanowire had a width of 70 to 80 nm and a length of about 8

### <Nanowire Dispersion>

About 0.08% by weight of an HPMC, about 0.36% by weight of the silver nanowires, about 0.005% by weight of ZONYL™ FSO-100, and about 99.555% by weight of water were mixed to prepare a nanowire dispersion (or an ink). First, an HPMC stock liquid was prepared. Water was added to a beaker and heated to a temperature of 80° C. to 85° C. by a hot plate. The amount of the added water was approximately ⅜ of the total water amount. An HPMC solution was added to the water, and the hot plate was turned off. The amount of the added HPMC solution was such that the HPMC content was 0.5% by weight in the mixture of the HPMC and water. The mixture was stirred to disperse the HPMC. The residual amount of water was cooled on ice, added to the heated HPMC mixture, and stirred at a high RPM for about 20 minutes. The resultant HPMC mixture was subjected to filtration using a 40-μm/70-μm (absolute/nominal) Cuno Betapure filter, to remove insoluble gels and particles. Then, a ZONYL™ FSO-100 stock liquid was prepared. Specifically, 10 g of ZONYL™ FSO-100 was added to 92.61 mL of water, and the resultant mixture was heated until the ZONYL FSO-100 was completely dissolved. The HPMC stock liquid was added to a container. The amount of the added HPMC stock liquid was such that the HPMC content was approximately 0.08% by weight in the final ink composition. A deionized water was added to the container. The amount of the added deionized water was such that the water content was approximately 99.555% by weight in the final ink composition. The resultant liquid was stirred for about 15 minutes, and thereto the silver nanowires were added. The amount of the added silver nanowires was such that the Ag nanowire content was approximately 0.36% by weight in the final ink composition. Finally, the ZONYL™ FSO-100 stock liquid was added to the mixture. The amount of the added ZONYL FSO-100 stock liquid was such that the ZONYL FSO-100 content was approximately 0.005% by weight in the final ink composition. In the obtained dispersion, the concentration of the silver nanowires (AgNW) was about 0.5% w/v, and the optical density thereof was about 0.5 (measured by SpectraMax M2 Plate Reader manufactured by Molecular Devices).

### <Formation of Silver Nanowire Network Layer>

A 5-μm-thick Autoflex EBG5 polyethylene terephthalate (PET) film was used as a substrate. The PET substrate was an optically transparent insulating body having a light transmittance of 91.6% and a haze of 0.78%. Unless otherwise specified, the light transmittance was measured by a method of ASTM D1003. The substrate was treated with an argon plasma before the nanowire deposition to be hereinafter described.

Then, the metal nanowires 10 were deposited on the substrate 12. Thus, the PET substrate was coated with the dispersion. The coating can be carried out using a coating technique such as a narrow channel measurement flow, a die flow, or an inclined flow, within the knowledge of those skilled in the art. It should be appreciated that the dispersion property and interconnectivity of the deposited metal nanowires 10 may be affected by the viscosity and shear behavior of the fluid as well as the interaction between the metal nanowires 10 in the fluid.

The silver nanowire coating layer was dried, whereby the water in the layer was evaporated to form a silver nanowire network layer. Thus, a film with exposed silver nanowires (the silver nanowire network layer) was formed on the PET substrate to prepare an AgNW/PET structure. The silver nanowire network layer had a light transmittance of 87.4% and a haze of 4.76%, measured by BYK Gardner Haze-gard Plus. The silver nanowire network layer had a surface resistance of 60 ohm/sq, measured by Fluke 175 True RMS Multimeter. The interconnectivity of the nanowires and the coated area ratio of the substrate can be observed by an optical microscope or a scanning electron microscope.

### <Pressure Treatment of Silver Nanowire Network Layer>

After the silver nanowire network layer was formed on the substrate 12, the silver nanowire network layer was subjected to a pressure treatment using a lower roller 186 and an upper roller 187. The conditions of the pressure treatment are shown in Table 1 below. In Example 1, a metal (stainless steel) roller having a hard chrome plating layer was used as the upper roller 187, a rubber roller having a rubber hardness of 40° was used as the lower roller 186, and a line pressure of 200 kgf/cm was applied to the silver nanowire network layer in the pressure treatment.

### <Production of Transparent Conductor>

After the silver nanowire network layer was pressed by the upper roller 187 and the lower roller 186, a matrix material was applied to the network layer.

The matrix material was a 1:4 (v/v) viscous solution prepared by mixing a polyurethane (PU) (Minwax quick-drying polyurethane) with methyl ethyl ketone (MEK). The matrix material was applied to the exposed silver nanowire film by a spin coating process. The coating may be carried out using another process known in the art, such as a doctor blade, Meyer rod, draw-down, or curtain coating process. The matrix material was hardened at the room temperature for about 3 hours. In this step, the solvent MEK was evaporated to harden the material. Alternatively, for example, the matrix material may be hardened in an oven at 50° C. for about 2 hours.

A transparent conductor (AgNW/PU/PET) of Example 1, which had the PET substrate and thereon the conductive layer 14, was produced in this manner. The conductive layer 14 containing the silver nanowires in the matrix 18 had a thickness of approximately 100 nm.

### Examples 2 to 4

Transparent conductors of Examples 2, 3, and 4 were produced in the same manner as in Example 1 except for using rubber rollers having rubber hardnesses of 50°, 60°, and 70° as the lower roller 186 in the pressure treatment, respectively.

### Comparative Examples 1 and 2

Transparent conductors of Comparative Examples 1 and 2 were produced in the same manner as in Example 1 except for using rubber rollers having rubber hardnesses of less than 40° and more than 70° as the lower roller 186 in the pressure treatment, respectively.

### [Evaluation]

The conductivity increase ratio of each transparent conductor was obtained using the formula (A-B)/A (%), wherein A represents the surface resistance of the precursor measured before the pressure treatment, and B represents the surface resistance of the resulting transparent conductor. The transparent conductor was evaluated as Excellent, Good, or Fair when the conductivity increase ratio was 95% or more, 90% or more but less than 95%, or less than 90%, respectively. The evaluation results are shown in Table 1.

TABLE 1

| | | Lower roller | | |
|---|---|---|---|---|
| | Upper | Rubber | Line pressure | Conductivity |
| | roller | hardness (°) | (kgf/cm) | evaluation |
| Comparative | Metal | <40° | 200 | Fair |
| Example 1 | | | | |
| Example 1 | Metal | 40° | 200 | Good |
| Example 2 | Metal | 50° | 200 | Excellent |
| Example 3 | Metal | 60° | 200 | Excellent |
| Example 4 | Metal | 70° | 200 | Good |
| Comparative | Metal | >70° | 200 | Fair |
| Example 2 | | | | |

It is clear from the evaluation results that the conductivity of the transparent conductor 16 can be significantly improved by using the lower roller 186 with a rubber hardness of 40° to 70°.

### Second Example

In Second Example, different line pressures were used under a constant rubber hardness condition in a pressure treatment of a silver nanowire network layer. Thus, the surface resistance difference between resultant transparent conductors 16 was evaluated.

### Examples 11 to 16

Transparent conductors of Examples 11, 12, 13, 14, 15, and 16 were produced in the same manner as in Example 1 except for using loads (line pressures) of 40, 100, 200, 300, 400, and 500 kgf/cm in the pressure treatment, respectively.

### Reference Examples 11 and 12

Transparent conductors of Reference Examples 11 and 12 were produced in the same manner as in Example 1 except for using loads (line pressures) of less than 40 kgf/cm and more than 500 kgf/cm in the pressure treatment, respectively.

### [Evaluation]

In the same manner as in First Example, the conductivity increase ratio of each transparent conductor was obtained using the formula (A-B)/A (%), wherein A represents the surface resistance of the precursor measured before the pressure treatment, and B represents the surface resistance of the resulting transparent conductor. The transparent conductor was evaluated as Excellent, Good, or Fair when the conductivity increase ratio was 95% or more, 90% or more but less than 95%, or less than 90%, respectively. The evaluation results are shown in Table 2.

TABLE 2

| | | Lower roller | | |
|---|---|---|---|---|
| | Upper | Rubber | Line pressure | Conductivity |
| | roller | hardness (°) | (kgf/cm) | evaluation |
| Reference | Metal | 55° | <40 | Fair |
| Example 11 | | | | |
| Example 11 | Metal | 55° | 40 | Good |
| Example 12 | Metal | 55° | 100 | Excellent |
| Example 13 | Metal | 55° | 200 | Excellent |
| Example 14 | Metal | 55° | 300 | Excellent |
| Example 15 | Metal | 55° | 400 | Good |
| Example 16 | Metal | 55° | 500 | Good |
| Reference | Metal | 55° | >500 | Fair |
| Example 12 | | | | |

It is clear from the evaluation results that the conductivity of the transparent conductor 16 can be significantly improved by applying a load (line pressure) of 40 to 500 kgf/cm to the silver nanowire network layer in the pressure treatment.

It is to be understood that the transparent conductor production method of the present invention is not limited to the above embodiments, and various changes and modifications may be made therein without departing from the scope of the present invention.

What is claimed is:

1. A method for producing a transparent conductor having a substrate and thereon a conductive layer containing a plurality of metal nanowires, wherein
the method comprises the steps of:
applying a coating liquid containing the metal nanowires in a liquid to the substrate,
removing the liquid to form a metal nanowire network layer on the substrate, and
subjecting the metal nanowire network layer to a pressure treatment using one or more rollers, and
wherein at least one roller among the one or more rollers has a rubber hardness of 40° to 70°.

2. A method according to claim 1, wherein in the pressure treatment, a load (line pressure) of 40 kgf/cm or more is applied to the metal nanowire network layer.

3. A method according to claim 1, wherein in the pressure treatment, a load (line pressure) of 40 to 500 kgf/cm is applied to the metal nanowire network layer.

4. A method according to claim 1, wherein the at least one roller is composed of a rubber.

5. A method according to claim 1, wherein in the pressure treatment, a first roller and a second roller are used for applying a pressure to the metal nanowire network layer, the first roller is brought into contact with the substrate, the second roller is arranged facing the first roller and is brought into contact with the metal nanowire network layer, and
at least the first roller has a rubber hardness of 40° to 70°.

6. A method according to claim 5, wherein the second roller is composed of a metal.
